(19) United States
(12) Patent Application Publication
(10) Pub. No.: US 2025/0372628 A1
(43) Pub. Date: Dec. 4, 2025

(54) POSITIVE ELECTRODE, PREPARATION METHOD THEREOF, AND RECHARGEABLE LITHIUM BATTERIES

(71) Applicants: SAMSUNG SDI CO., LTD., Yongin-si (KR); IUCF-HYU (Industry-University Cooperation Foundation Hanyang University), Seoul (KR)

(72) Inventors: Keemin PARK, Yongin-si (KR); Hyunhee KIM, Yongin-si (KR); Seungcheol MYEONG, Seoul (KR); Taeseup SONG, Seoul (KR)

(73) Assignees: SAMSUNG SDI CO., LTD., Yongin-si (KR); IUCF-HYU (Industry-University Cooperation Foundation Hanyang University), Seoul (KR)

(21) Appl. No.: 19/086,337

(22) Filed: Mar. 21, 2025

(30) Foreign Application Priority Data
Jun. 3, 2024 (KR) 10-2024-0072551

(51) Int. Cl. H01M 4/36; H01M 4/02; H01M 4/04; H01M 4/62; H01M 10/052

(52) U.S. Cl. CPC H01M 4/366; H01M 4/0404; H01M 4/623; H01M 4/625; H01M 10/052; H01M 2004/021; H01M 2004/028

(57) ABSTRACT

Disclosed are a positive electrode, a preparation method thereof, and a rechargeable lithium battery including the positive electrode. The positive electrode includes a positive electrode current collector, a positive electrode active material layer on the positive electrode current collector, and a positive electrode coating layer between the positive electrode current collector and the positive electrode active material layer. The positive electrode coating layer includes a graphite-based material, a phosphorus-based extinguishing agent, and a binder, and the positive electrode coating layer includes about 1 part by weight to about 45 part by weight of the phosphorus-based extinguishing agent based on 100 parts by weight of a total of the graphite-based material and the phosphorus-based extinguishing agent.

### CROSS-REFERENCE TO RELATED APPLICATION

This application claims the benefit of priority to Korean Patent Application No. 10-2024-0072551 filed in the Korean Intellectual Property Office on Jun. 3, 2024, the entire contents of which being incorporated herein by reference.

### BACKGROUND

### 1. Field

Positive electrodes and preparation methods thereof, and rechargeable lithium batteries including the positive electrodes are disclosed.

### 2. Description of the Related Art

A portable information device such as a cell phone, a laptop, smart phone, and the like, or an electric vehicle, typically use a rechargeable lithium battery having high energy density and easier portability as a driving power source. Accordingly, a rechargeable lithium battery with high energy density as a driving power source or power storage power source for hybrid or electric vehicles may be advantageous.

Rechargeable lithium batteries typically include a positive electrode and a negative electrode including an active material capable of intercalating and deintercalating lithium ions, and an electrolyte solution, and electrical energy is produced through oxidation and reduction reactions when lithium ions are intercalated/deintercalated from the positive electrode and negative electrode.

Transition metal compounds such as, e.g., lithium cobalt-based oxide, lithium nickel-based oxide, and lithium manganese-based oxide are typically used as positive electrode active materials for rechargeable lithium batteries, and crystalline carbon materials such as natural graphite or artificial graphite or amorphous carbon materials are typically used as negative electrode active materials.

### SUMMARY

Some example embodiments include a positive electrode capable of securing desired or improved capacity characteristics and cycle-life characteristics while ensuring safety by exhibiting an effect of reducing heat generation through resistance increase when an abnormal temperature occurs and an extinguishing effect when ignited, and a preparation method thereof, and a rechargeable lithium battery.

Some example embodiments include a positive electrode including a positive electrode current collector, a positive electrode active material layer on the positive electrode current collector, and a positive electrode coating layer between the positive electrode current collector and the positive electrode active material layer. The positive electrode coating layer includes a graphite-based material, a phosphorus-based extinguishing agent, and a binder, and the positive electrode coating layer includes about 1 part by weight to about 45 part by weight of the phosphorus-based extinguishing agent based on 100 parts by weight of a total of the graphite-based material and the phosphorus-based extinguishing agent.

Some example embodiments include a method of preparing a positive electrode that includes mixing a graphite-based material into a solution including a phosphorus extinguishing agent to obtain a mixed solution, mixing potassium permanganate into the mixed solution to obtain a first solution, mixing hydrogen peroxide into the first solution to obtain a second solution, mixing an acetic acid solution with the second solution to obtain a third solution, and drying a resulting mixture, mixing the resulting mixture with a solvent to obtain a slurry for forming a positive electrode coating layer, coating the slurry on the positive electrode collector, and drying the slurry to form a positive electrode coating layer, and forming a positive electrode active material layer on the positive electrode coating layer. The positive electrode coating layer includes about 1 part by weight to about 45 part by weight of the phosphorus-based extinguishing agent based on 100 parts by weight of a total of the graphite-based material and the phosphorus-based extinguishing agent.

Some example embodiments include a rechargeable lithium battery including the aforementioned positive electrode, a negative electrode, and an electrolyte.

According to some example embodiments, a positive electrode and a preparation method thereof, and a rechargeable lithium battery can be provided, which exhibits improved safety while ensuring desired or improved capacity characteristics and cycle-life characteristics by exhibiting the effect of reducing heat generation through resistance increase in the event of an abnormal temperature occurrence and exhibiting an extinguishing effect in the event of ignition.

### BRIEF DESCRIPTION OF THE DRAWINGS

FIGS. 1 to 4 are cross-sectional views schematically illustrating rechargeable lithium batteries, according to some example embodiments.

FIG. 5 shows the results of measuring the weight change in the range of 50° C. to 700° C. using a thermogravimetric analyzer (TGA) for expandable graphite-based materials in which phosphoric acid is inserted as an intercalator into graphite oxide prepared in Preparation Examples 1 to 3.

FIG. 6 shows the results of evaluating the expansion rate by measuring the volume change in the range of 50° C. to 350° C. for expandable graphite-based materials in which phosphoric acid is inserted as an intercalator into graphite oxide prepared in Preparation Examples 1 to 3.

FIG. 7 shows the results of analyzing the P 2p spectrum using X-ray photoelectron spectroscopy (XPS) for an expandable graphite-based material in which 20 parts by weight of phosphoric acid (H₃PO₄) is inserted as an intercalator into general graphite and graphite oxide prepared in Preparation Example 1.

FIG. 8 shows the results of analyzing the lattice structure of an expandable graphite-based material in which 20 parts by weight of phosphoric acid (H₃PO₄) is inserted as an intercalator into general graphite and graphite oxide prepared in Preparation Example 1, using X-ray diffraction analysis (XRD).

FIG. 9 shows the results of evaluating the electronic conductivity of an expandable graphite-based material in which phosphoric acid (H₃PO₄) is inserted as an intercalator into general graphite and graphite oxide prepared in Preparation Example 1, before and after expansion at greater than or equal to 100° C.

FIG. 10 is an image taken by a scanning electron microscope (SEM) of a positive electrode specimen according to Example 1 before heat treatment at 150° C.

FIG. 11 is an image of a positive electrode specimen according to Example 1 taken using a scanning electron microscope (SEM) after heat treatment at 150° C.

FIG. 12 shows the results of measuring the change in resistance before and after heat treatment at a temperature of 150° C. for the rechargeable lithium battery cells manufactured in Comparative Example 1 and Example 3.

FIG. 13 shows the results of a simulation evaluation conducted on the rechargeable lithium battery cell manufactured in Comparative Example 1 when a short circuit occurs due to a temperature increase.

FIG. 14 shows the results of a simulation evaluation conducted on the rechargeable lithium battery cell manufactured in Example 1 when a short circuit occurs due to a temperature increase.

FIG. 15 shows the results of a simulation evaluation conducted on the rechargeable lithium battery cell manufactured in Example 2 when a short circuit occurs due to a temperature increase.

FIG. 16 shows the results of a simulation evaluation conducted on the rechargeable lithium battery cell manufactured in Example 3 when a short circuit occurs due to a temperature increase.

FIG. 17 shows the results of measuring the extinguishing time upon ignition for the rechargeable lithium battery cells manufactured in Comparative Example 1 and Example 3.

FIG. 18 shows the results of measuring voltage changes according to capacity for the rechargeable lithium battery cells manufactured in Comparative Example 1 and Examples 1 to 3.

FIG. 19 shows the results of measuring the capacity retention rates according to the number of cycles for the rechargeable lithium battery cells manufactured in Comparative Example 1 and Examples 1 to 3.

FIG. 20 is a flow chart illustrating a method of preparing a positive electrode, according to examples of the disclosure.

### DETAILED DESCRIPTION

Hereinafter, example embodiments are described in detail so that those of ordinary skill in the art can readily implement the example embodiments. However, this disclosure may be embodied in many different forms and is not construed as limited to the example embodiments set forth herein.

The terminology used herein is used to describe example embodiments only, and is not intended to limit the present disclosure. The singular expression includes the plural expression unless the context clearly dictates otherwise.

As used herein, “combination thereof” indicates a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout the specification. It is understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D₅₀) of particles having a cumulative volume of 50 volume % in the particle size distribution. As used herein, when a definition is not otherwise provided, the average particle diameter indicates a diameter (D₅₀) of particles having a cumulative volume of 50 volume % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Positive Electrode

In some example embodiments, a positive electrode includes a positive electrode current collector, a positive electrode active material layer on the positive electrode current collector, and a positive electrode coating layer between the positive electrode current collector and the positive electrode active material layer, wherein the positive electrode coating layer includes a graphite-based material, a phosphorus-based extinguishing agent, and a binder, and the positive electrode coating layer includes about 1 part by weight to about 45 part by weight of the phosphorus-based extinguishing agent based on 100 parts by weight of a total of the graphite-based material and the phosphorus-based extinguishing agent.

A rechargeable lithium battery is a widely used energy storage device due to high energy density, desired or improved output characteristics, high charge and discharge efficiency, and stable cycle-life characteristics. With the development of the electric vehicle industry, rechargeable batteries capable of exhibiting higher energy density and output characteristics are advantageous.

However, the improvement of energy density and output characteristics of rechargeable batteries entails a potential disadvantage of deteriorating battery safety by increasing a risk of short-circuits and fires caused by internal and external factors.

In order to improve the safety of rechargeable batteries, methods to hinder or block additional Joule heat generation by introducing structures or materials capable of interrupting operation of the rechargeable batteries, or to provide fire-extinguishing effects, when a temperature abnormally occurs by using flame-retardant materials, may be advantageous.

However, there are various side effects such as, e.g., deteriorated performance of the rechargeable batteries, decreased density due to increased volume or weight, and the like, due the fact that the materials have low electrochemical safety and act as resistors.

Accordingly, some example embodiments include a positive electrode coating layer capable of reducing Joule heat generation by increasing resistance, when a temperature abnormally rises, and extinguishing fires, when ignited, while realizing desired or improved capacity characteristics and cycle-life characteristics under normal conditions. The positive electrode coating layer may be introduced into a positive electrode to secure desired or improved safety and performance of rechargeable lithium batteries.

The positive electrode includes a positive electrode current collector, and a positive electrode active material layer on the positive electrode current collector. The positive electrode current collector may be or include Al, but is not limited thereto.

### Positive Electrode Coating Layer

The positive electrode includes a positive electrode coating layer between the positive electrode current collector and the positive electrode active material layer, and the positive electrode coating layer includes a graphite-based material, a phosphorus-based extinguishing agent, and a binder. The positive electrode coating layer may constitute a safety functional layer in the event of an abnormal temperature occurrence or ignition, and by introducing the positive electrode coating layer including the graphite-based material, phosphorus-based extinguishing agent, and binder to the positive electrode, the safety of the battery may be improved or secured.

The positive electrode coating layer includes about 1 part by weight to about 45 part by weight, for example about 5 parts by weight to about 40 parts by weight, about 10 parts by weight to about 30 parts by weight, or about 15 parts by weight to about 25 parts by weight of the phosphorus-based extinguishing agent based on 100 parts by weight of a total of the graphite-based material and the phosphorus-based extinguishing agent. In any of the above ranges, the safety of the battery may be ensured by performing electronic conduction hindering or blocking and extinguishing actions when, or only when, an abnormal temperature occurrence or ignition occurs, without deteriorating capacity characteristics or cycle-life characteristics of the battery under normal conditions.

In the positive electrode coating layer, the graphite-based material reduces Joule heat through the graphite-based material's own resistance increase when the temperature rises abnormally, or through an increase in the resistance of the negative electrode that occurs as a distance between a substrate and a mixture layer increases.

Examples of such graphite-based materials may include at least one of a plate-shaped graphite-based material, a flake-shaped graphite-based material, a massive graphite-based material, or a combination thereof, and a representative example may include a plate-shaped graphite-based material. When the above is met, the graphite-based material can constitute a resistor on its own or increase the resistance between a substrate and a mixture layer when an abnormal temperature rise or ignition occurs.

In some example embodiments, the graphite-based material may be or include a plate-shaped graphite-based material, and may include, for example, at least one of graphite, graphite oxide, graphene, graphene oxide, or a combination thereof. The graphite-based material may include not only graphite, but also materials derived from graphite, such as at least one of graphite oxide, graphene, and graphene oxide. When the above condition for the graphite-based material is satisfied, the effect of hindering or blocking electronic conduction can be effectively achieved only when an abnormal temperature occurrence or ignition occurs, while effectively securing conductivity under normal conditions.

For example, the graphite-based material may be or include an expandable graphite-based material having a property of expanding according to temperature change, and a representative example of the expandable graphite-based material may be graphite oxide.

In some example embodiments, the graphite-based material may expand at a temperature of about 100° C. or higher, for example, can expand at a temperature greater than or equal to about 100° C., for example greater than or equal to about 120° C., greater than or equal to about 150° C., about 120° C. to about 350° C., or about 150° C. to about 350° C. The above temperature ranges may constitute abnormal temperatures as discussed in this disclosure. The graphite-based materials normally exhibit desired or improved conductivity, but when the temperature rises to a specific range of greater than or equal to about 100° C., the graphite-based materials expand and can act as resistors. When the temperature rises to an abnormal range indicated above, or a fire occurs, the volume of the graphite-based material in the positive electrode coating layer can increase, and in particular, as the interlayer distance of the plate-shaped graphite-based material increases, a mechanism for hindering or blocking conduction between the substrate and mixture layer can be performed.

For example, the graphite-based material includes graphite, graphite oxide, or a combination thereof, and the graphite-based material can change to graphene, graphene oxide, or a combination thereof at a temperature greater than or equal to about 100° C. (e.g., greater than or equal to about 120° C., greater than or equal to about 150° C., about 120° C. to about 350° C., or about 150° C. to about 350° C.). When the above is met, the safety of the battery can be effectively secured.

For example, the graphite-based material includes graphite oxide, and the graphite oxide can change into graphene oxide at a temperature greater than or equal to about 100° C. (e.g., greater than or equal to about 120° C., greater than or equal to about 150° C., about 120° C. to about 350° C., or about 150° C. to about 350° C.). When the temperature is below the above ranges, graphite oxide is within the positive electrode active material layer in its stable form, but when an abnormal temperature, such as a temperature within the above temperature ranges, occurs or ignition occurs, the graphite oxide changes into a substance such as graphene oxide, and can increase resistance through the separation between the substrate and mixture layer.

For example, the positive electrode coating layer may include the graphite-based material in an amount in a range of about 50 wt % to about 99.5 wt %, for example, about 60 wt % to about 95 wt %, about 70 wt % to about 90 wt %, or about 74 wt % to about 85 wt %, based on 100 wt % of the positive electrode coating layer. In this range, the effect of securing normal battery performance and ensuring safety in the event of abnormal temperature occurrence or ignition can be improved or maximized.

In addition to the graphite-based material, the positive electrode coating layer may include the phosphorus-based extinguishing agent, for example, at least one of phosphoric acid, phosphate salt, phosphorous acid, a phosphite salt, pyrophosphoric acid, a pyrophosphate salt, metaphosphoric acid, a metaphosphate salt, triphosphoric acid, a triphosphate salt, tetraphosphoric acid, a tetraphosphate salt, polyphosphoric acid, a polyphosphate salt, or a combination thereof. When using these extinguishing agents, the extinguishing agents can be decomposed into CO₂ or PO radicals and may thus have an extinguishing effect when a fire occurs.

In one example embodiment, at normal times or at temperatures lower than about 100° C., the phosphorus extinguishing agent may be present in a form included within the graphite-based material, and for example, the phosphorus extinguishing agent may be inserted between layers of the graphite-based material. When the above is met, the phosphorus extinguishing agent may not normally function because it is contained within the graphite material (e.g., between the layers) in the positive electrode coating layer or exists in an inserted form.

For example, at a temperature greater than or equal to about 100° C. (e.g., greater than or equal to about 120° C., greater than or equal to about 150° C., about 120° C. to about 350° C., or about 150° C. to about 350° C.), the phosphorus extinguishing agent may come out or decompose within the interior of the graphite-based material (or between layers of the graphite-based material) to perform the extinguishing action.

According to some example embodiments, by coating an expandable graphite-based material in which a phosphorus-based extinguishing agent (e.g., phosphoric acid (H₃PO₄)) is used as an intercalator in graphite oxide, the effect of hindering or blocking electronic conduction due to expansion of the expandable graphite-based material when the temperature rises and the effect of extinguishing fire due to decomposition of the PO₄³⁻ phosphorus intercalator when an actual fire occurs can be simultaneously or contemporaneously secured. In addition, by using a material having a conductivity equivalent to the conductivity of graphite as the positive electrode coating layer material before the expansion reaction, the deterioration of electrochemical characteristics due to this functional layer can be reduced, and even with a very low thickness of less than or equal to about 2 μm, the role of the safety functional layer can be performed, so that the loss of energy density can also be reduced compared to the conventional thick safety functional layer of 15 μm.

The positive electrode coating layer may include the phosphorus extinguishing agent in an amount in a range of about 0.5 wt % to about 45 wt %, for example, about 4 wt % to about 40 wt %, about 9 wt % to about 30 wt %, about 10 wt % to about 25 wt %, or about 16 wt % to about 23 wt %, based on 100 wt % of the positive electrode coating layer. Within any of the above ranges, the extinguishing effect by decomposition of the PO₄³⁻ phosphorus intercalator may be improved or maximized in the event of an actual fire.

The positive electrode coating layer may include about 55 parts by weight to about 99 parts by weight, for example about 60 parts by weight to about 95 parts by weight, about 70 parts by weight to about 90 parts by weight, or about 75 parts by weight to about 85 parts by weight, of the graphite-based material based on 100 parts by weight of a total of the graphite-based material and the phosphorus-based extinguishing agent. The above positive electrode coating layer can be advantageous in securing desired or improved battery performance under normal conditions or before an expansion reaction, and can be advantageous in securing battery safety by effectively performing the role of hindering or blocking electronic conduction when there is an abnormal temperature increase or after expansion.

In some example embodiments, the positive electrode coating layer may not include a positive electrode active material.

In examples, the positive electrode coating layer includes a binder. In the positive electrode coating layer, the binder is configured to ensure that the components within the layers adhere to each other and to the adjacent layers, namely the positive electrode current collector and positive electrode active material layer.

The binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, or a combination thereof, but is not particularly limited thereto.

Examples of the binder may include a fluorine-based binder, and by using the fluorine-based binder in this way, the binder addition may be harmoniously performed without lowering the safety function of the aforementioned graphite-based material and phosphorus-based extinguishing agent. For example, the binder used in the positive electrode coating layer may include at least one of polytetrafluoroethylene, polyvinylidene fluoride (PVdF), or a combination thereof.

For example, the positive electrode coating layer may include the binder in an amount in a range of about 0.1 wt % to about 5 wt %, for example, about 0.5 wt % to about 4 wt %, about 0.8 wt % to about 3.5 wt %, or about 1 wt % to about 3 wt %, based on 100 wt % of the positive electrode coating layer. In any of the above ranges, adding a binder can be harmoniously performed without compromising the effect of ensuring safety by adding a graphite-based material and a phosphorus-based extinguishing agent.

In some example embodiments, an average thickness of the positive electrode coating layer may be in a range of about 0.1 μm to about 20 μm, for example about 0.1 μm to about 15 μm, about 0.2 μm to about 13 μm, about 0.3 μm to about 10 μm, about 0.4 μm to about 8 μm, about 0.5 μm to about 5 μm, about 0.8 μm to about 3 μm, or about 1 μm to about 2 μm. In any of the above ranges, the positive electrode coating layer can perform the role of a safety functional layer, and safety may be secured even with a lower thickness than conventional thicknesses, thereby reducing the loss of energy density.

For example, at a temperature greater than or equal to about 100° C. (e.g., greater than or equal to about 120° C., greater than or equal to about 150° C., about 120° C. to about 350° C., about 100° C. to about 150° C., or about 150° C. to about 350° C.), the positive electrode coating layer may expand, for example, increase in thickness compared to before the expansion (or less than 100° C.), and may increase in a range of about 1.5 to about 3 times compared to before the expansion (at a temperature that is less than about 100° C.). In this range, in the event of an abnormal temperature rise or ignition, the electronic conduction hindering or blocking effect may be sufficiently exerted to effectively perform its role as a safety functional layer. Whether the positive electrode coating layer has expanded or increased in thickness may be evaluated based on the average thickness within the positive electrode coating layer, and compared with the area corresponding to the average thickness based on the evaluation specimen.

### Positive Electrode Active Material Layer

In some example embodiments, the positive electrode active material layer may include at least one of a positive electrode active material, a binder, a conductive material, or a combination thereof.

The positive electrode active material may be or include a compound capable of reversible intercalation and deintercalation of lithium (lithiated intercalation compound). For example, one or more types of composite oxides of lithium and a metal such as or including at least one of cobalt, manganese, nickel, and a combination thereof may be used.

The composite oxide may be or include at least one of a lithium transition metal composite oxide, and examples thereof may include at least one of a lithium nickel-based oxide, a lithium cobalt-based oxide, a lithium manganese-based oxide, a lithium iron phosphate-based compound, a cobalt-free nickel-manganese-based oxide, a lithium-rich layered oxide, or a combination thereof.

For example, the positive electrode active material may be or include a high-nickel positive electrode active material having a nickel content of 80 mol % or more based on 100 mol % of metal excluding lithium in a lithium transition metal composite oxide. The nickel content in the high-nickel-based positive electrode active material may be greater than or equal to about 85 mol %, greater than or equal to about 90 mol %, greater than or equal to about 91 mol %, or greater than or equal to about 94 mol % and less than or equal to about 99 mol % based on 100 mol % of metals excluding lithium. The high-nickel-based positive electrode active materials can achieve high capacity and can be applied to high-capacity, high-density rechargeable lithium batteries.

As a more specific example, a compound represented by any of the following chemical formulas can be used. LiₐA_{1-b}X₆O_{2-c}D_{c} (0.90≤a≤1.8, 0≤b≤0.5, 0≤c≤0.05); LiₐMn_{2-b}X₆O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8)

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; Q is or includes at least one of Ti, Mo, Mn, or a combination thereof; Z is or includes at least one of Cr, V, Fe, Sc, Y, or a combination thereof; and L¹ is or includes at least one of Mn, Al or a combination thereof.

In the positive electrode active material layer, the binder is configured to attach positive electrode active material particles to each other, and to attach positive electrode active material to adjacent layers. Representative examples of the binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but are not limited thereto.

In the positive electrode active material layer, the conductive material is used to provide conductivity to the electrode, and any electronically conductive material that does not cause a chemical change in the battery to be formed may be used. Examples of the conductive material may include a carbon-based material such as or including at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

In the positive electrode active material layer, each content of the binder and the conductive material may be about 0.5 wt % to about 5 wt %, based on 100 wt % of the positive electrode active material layer.

### Method of Preparing Positive Electrode

In some example embodiments, a method of preparing a positive electrode includes mixing a graphite-based material into a solution including a phosphorus extinguishing agent to obtain a mixed solution, mixing potassium permanganate into the mixed solution to obtain a first solution, mixing hydrogen peroxide into the first solution to obtain a second solution, mixing an acetic acid solution with the second solution to obtain a third solution, and subsequently drying the resulting mixture, mixing the resulting mixture with a solvent to obtain a slurry for forming a positive electrode coating layer, coating the slurry on the positive electrode collector, and drying the slurry to form a positive electrode coating layer, and forming a positive electrode active material layer on the positive electrode coating layer. The positive electrode coating layer includes about 1 part by weight to about 45 part by weight of the phosphorus-based extinguishing agent based on 100 parts by weight of a total of the graphite-based material and the phosphorus-based extinguishing agent.

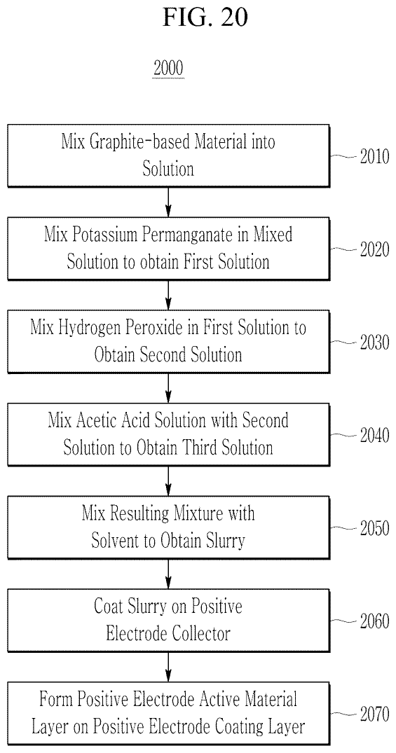

The above description relates to the method for manufacturing the positive electrode according to some example embodiments. Hereinafter, the overlapped description of the positive electrode with the above description is omitted, and a process of manufacturing the positive electrode according to some example embodiments is described in detail below and also with reference to FIG. 20 described below.

First, a solution including a phosphorus extinguishing agent is mixed with a graphite-based material to obtain a mixed solution. The mixed solution including the phosphorus extinguishing agent may further include sodium nitrate (NaNO₃).

For example, the mixing of the solution including the phosphorus extinguishing agent with the graphite-based material may be performed at a temperature in a range of about 20° C. to about 100° C. or for example, about 20° C. to about 50° C. by stirring at a rate in a range of about 50 rpm to about 500 rpm, for example, about 200 rpm to about 300 rpm.

In some example embodiments, the mixing of the solution including the phosphorus extinguishing agent and the graphite-based material may be performed by stirring for about 1 hour to about 24 hours, for example, for about 1 hour to about 3 hours.

Subsequently, potassium permanganate is added to the mixed solution to obtain the first solution. For example, the mixing of the potassium permanganate and the mixed solution may be performed at about 20° C. to about 100° C., for example, about 20° C. to about 50° C. by stirring under the condition of about 50 rpm to about 500 rpm, for example, about 200 rpm to about 300 rpm. For example, the mixing of the potassium permanganate with the mixed solution of the phosphorus extinguishing agent and the graphite-based material may be performed by stirring for about 1 hour to about 24 hours, for example, for about 2 hours to about 5 hours.

Subsequently, the first solution is mixed with hydrogen peroxide to obtain the second solution. For example, the mixing of the first solution with the hydrogen peroxide may be performed at about 80° C. to about 150° C. by stirring under the above temperature condition of about 50 rpm to about 500 rpm. For example, the mixing of the first solution with the hydrogen peroxide may be performed by stirring for about 10 minutes to about 5 hours, for example, for about 30 minutes to about 2 hours.

Subsequently, the second solution is mixed with acetic acid (CH₃COOH) to obtain the third solution, and dried to obtain the resulting mixture. For example, the mixing of the second solution with the acetic acid solution may be performed at about 10° C. to about 80° C. by stirring under the condition of about 50 rpm to about 500 rpm. For example, the mixing of the second solution with the acetic acid solution may be performed by stirring for about 10 minutes to about 1 hour. When the above conditions are all satisfied, the expandable graphite-based material may be effectively obtained

In some example embodiments, the acetic acid solution may be at a concentration of about 99.7% or more.

For example, in the manufacturing method, the acetic acid solution may be adjusted to be about 5 parts by weight to about 20 parts by weight based on 100 parts by weight of the mixed solution of the solution including the phosphorus extinguishing agent with the graphite-based material and the acetic acid solution.

In some example embodiments, in order to further acid-treat the resultant, the resulting mixture may be further mixed with a solution including a phosphorus extinguishing agent. For example, the mixing of the resulting mixture and the solution including a phosphorus extinguishing agent may be performed at about 20° C. to about 100° C., for example, about 20° C. to about 50° C. by stirring under the condition of about 50 rpm to about 500 rpm, for example, about 200 rpm to about 300 rpm. The mixing of the resulting mixture and the solution including the phosphorus extinguishing agent may be performed for about 1 hour to about 24 hours, for example, for about 10 hours to about 15 hours.

Subsequently, the resulting mixture is mixed with a solvent to obtain the slurry for forming a positive electrode coating layer. Herein, the solvent may be NMP but is not particularly limited thereto.

For example, the slurry may further include a binder, to which the above description of the binder included in the positive electrode coating layer may be equally applied and thus will not be repetitively illustrated.

The slurry is coated on a positive electrode current collector and dried to form a positive electrode coating layer. The coating may be performed in any common method without any particular limit.

In some example embodiments, the drying may be performed, e.g., in a convection oven. For example, the drying may be performed at about 50° C. to about 200° C., for example, about 80° C. to about 150° C., or about 100° C. to about 120° C. Herein, the positive electrode coating layer may be described by equally applying the above description.

On the positive electrode coating layer, a positive electrode active material layer may be formed, wherein the positive electrode active material layer may be described by equally applying the above description.

The positive electrode coating layer (or the slurry) may include the phosphorus-based extinguishing agent in an amount in a range of about 1 part by weight to about 45 parts by weight, for example, about 5 parts by weight to about 40 parts by weight, about 10 parts by weight to about 30 parts by weight, or about 18 parts by weight to about 22 parts by weight based on 100 parts by weight of a total of the graphite-based material and the phosphorus-based extinguishing agent. Within the above ranges, a positive electrode capable of securing battery safety without deteriorating battery performance under the normal conditions may be obtained.

### Rechargeable Lithium Battery

Some example embodiments include a rechargeable lithium battery including the aforementioned positive electrode, negative electrode, and electrolyte. As an example, a rechargeable lithium battery may include a positive electrode, a negative electrode, a separator between the positive electrode and the negative electrode, and an electrolyte solution.

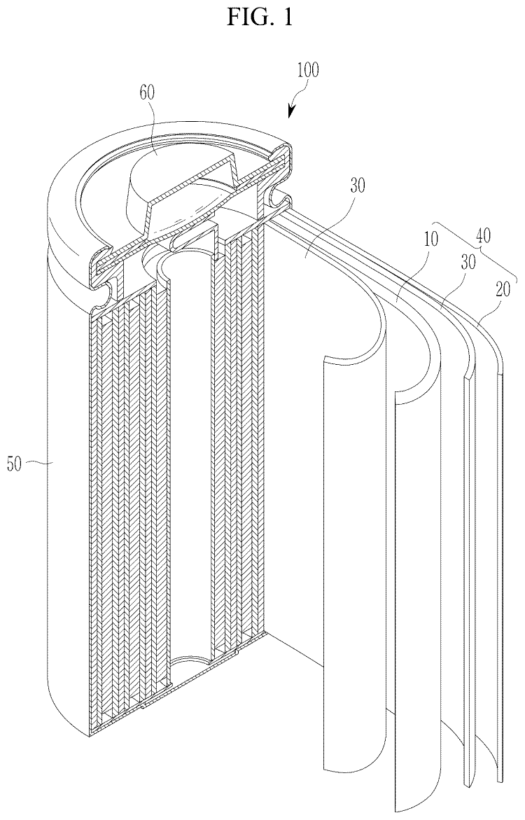

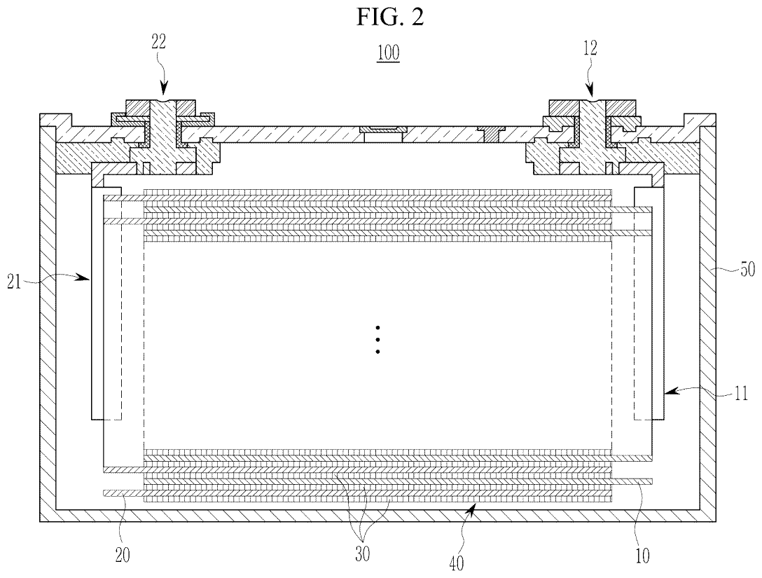

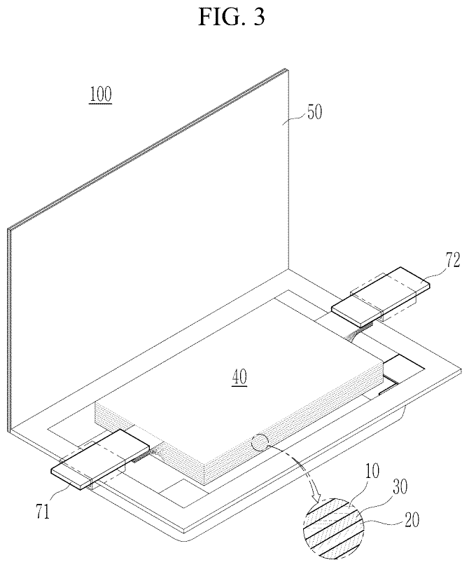

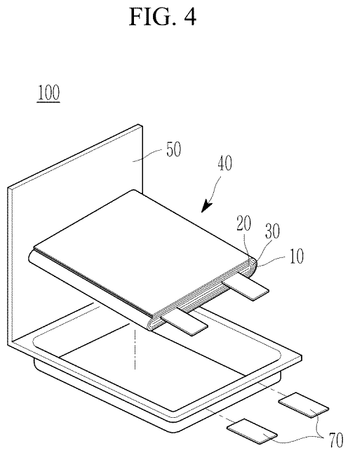

The rechargeable lithium battery may be classified into cylindrical, prismatic, pouch, coin, etc. depending on the shape. FIGS. 1 to 4 are schematic diagrams illustrating the rechargeable lithium battery according to some example embodiments, where FIG. 1 illustrates a cylindrical battery, FIG. 2 illustrates a prismatic battery, and FIGS. 3 and 4 illustrate a pouch-shaped battery. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12, a negative lead tab 21, and a negative electrode terminal 22. As shown in FIGS. 3 and 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electrical path for inducing the current formed in the electrode assembly 40 to the outside of the battery 100.

### Negative Electrode

The negative electrode may include a current collector and a negative electrode active material layer on the current collector, and the negative electrode active material layer may include a negative electrode active material, and may further include a binder, a conductive material, or a combination thereof.

### Negative Electrode Active Material

The negative electrode active material may include at least one of a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be at least one of irregular, or sheet, flake, spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is an element such as or including at least one of an alkali metal, an alkaline-earth metal, a Group 13 element, a Group 14 element (excluding Si), a Group 15 element, a Group 16 element, a transition metal, a rare earth element, and a combination thereof, for example Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof), or a combination thereof. The Sn-based negative electrode active material may be or include at least one of Sn, SnO₂, a Sn alloy, or a combination thereof.

The silicon-carbon composite may be or include a composite of silicon and amorphous carbon. An average particle diameter (D₅₀) of the silicon-carbon composite particles may be, for example, in a range of about 0.5 μm to about 20 μm. According to some example embodiments, the silicon-carbon composite may be in the form of silicon particles and amorphous carbon coated on the surface of the silicon particles. For example, the silicon-carbon composite may include a secondary particle (core) in which silicon primary particles are assembled and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be or include at least one of artificial graphite, natural graphite, or a combination thereof. The amorphous carbon may include at least one of soft carbon or hard carbon, a mesophase pitch carbonized product, and calcined coke.

When the silicon-carbon composite includes silicon and amorphous carbon, a silicon content may be in a range of about 10 wt % to about 50 wt % and a content of amorphous carbon may be about 50 wt % to about 90 wt % based on 100 wt % of the silicon-carbon composite. In addition, when the composite includes silicon, amorphous carbon, and crystalline carbon, a silicon content may be about 10 wt % to about 50 wt %, a content of crystalline carbon may be about 10 wt % to about 70 wt %, and a content of amorphous carbon may be about 20 wt % to about 40 wt % based on 100 wt % of the silicon-carbon composite.

Additionally, a thickness of the amorphous carbon coating layer may be in a range of about 5 nm to about 100 nm. An average particle diameter (D₅₀) of the silicon particles (primary particles) may be in a range of about 10 nm to about 1 μm, or about 10 nm to about 200 nm. The silicon particles may exist as silicon alone, in the form of a silicon alloy, or in an oxidized form. The oxidized form of silicon may be represented by SiOₓ (0<x≤2). At this time, the atomic content ratio of Si:O, which indicates a degree of oxidation, may be about 99:1 to about 33:67. As used herein, when a definition is not otherwise provided, an average particle diameter (D₅₀) indicates a particle where a cumulative volume is about 50 volume % in a particle distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed and used, the mixing ratio may be a weight ratio in a range of about 1:99 to about 90:10.

### Binder

The binder is configured to adhere the negative electrode active material particles to each other, and to adhere the negative electrode active material to the current collector. The binder may be or include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be or include at least one of Na, K, or Li.

The dry binder may be or include a polymer material capable of becoming fiber, and may be or include, for example, at least one of polytetrafluoroethylene, polyvinylidene fluoride, a polyvinylidene fluoride-hexafluoropropylene copolymer, polyethylene oxide, or a combination thereof.

### Conductive Material

The conductive material is included to provide electrode conductivity, and any electrically conductive material may be used as a conductive material unless the electrically conductive material causes a chemical change. Examples of the conductive material include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

A content of the negative electrode active material may be about 95 wt % to about 99.5 wt % based on 100 wt % of the negative electrode active material layer, and a content of the binder may be in a range of about 0.5 wt % to about 5 wt % based on 100 wt % of the negative electrode active material layer. For example, the negative electrode active material layer may include about 90 wt % to about 99 wt % of the negative electrode active material, about 0.5 wt % to about 5 wt % of the binder, and about 0.5 wt % to about 5 wt % of the conductive material.

### Current Collector

The negative electrode current collector may include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. A thickness of the negative electrode current collector may be, for example, in a range of about 1 μm to about 20 μm, about 5 μm to about 15 μm, or about 7 μm to about 10 μm.

### Electrolyte

For example, the electrolyte for a rechargeable lithium battery may be or include an electrolyte solution, which may include a non-aqueous organic solvent and a lithium salt.

The non-aqueous organic solvent may constitute a medium for transmitting ions taking part in the electrochemical reaction of a battery. The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like and the aprotic solvent may include at least one of nitriles such as R—CN (wherein R is a C2 to C20 linear, branched, or cyclic hydrocarbon group, a double bond, an aromatic ring, or an ether group, and the like); amides such as dimethylformamide; dioxolanes such as 1,3-dioxolane, 1,4-dioxolane, and the like; sulfolanes, and the like.

The non-aqueous organic solvent can be used alone or in a mixture of two or more types of solvent, and when two or more types of solvent are used in a mixture, a mixing ratio can be appropriately adjusted according to the desired battery performance, which is widely known to those skilled in the field.

When using a carbonate-based solvent, a cyclic carbonate and a chain carbonate may be mixed and used, and the cyclic carbonate and the chain carbonate may be mixed in a volume ratio in a range of about 1:1 to about 1:9.

The non-aqueous organic solvent may further include an aromatic hydrocarbon-based organic solvent. For example, a carbonate-based solvent and an aromatic hydrocarbon-based organic solvent may be mixed and used in a volume ratio in a range of about 1:1 to about 30:1.

The electrolyte solution may further include at least one of vinylethyl carbonate, vinylene carbonate, or an ethylene carbonate-based compound to improve battery cycle-life.

Examples of the ethylene carbonate-based compound may include at least one of fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the organic solvent supplies lithium ions in a battery, enables a basic operation of a rechargeable lithium battery, and improves transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl) imide; LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethane sulfonate, lithium difluorobis(oxalato) phosphate (LiDFOB), and lithium bis(oxalato) borate (LiBOB).

A concentration of lithium salt may be within the range of about 0.1 M to about 2.0 M. When the concentration of lithium salt is within the above range, the electrolyte solution has appropriate ionic conductivity and viscosity, and thus desired or improved performance can be achieved and lithium ions can move effectively.

### Separator

Depending on the type of rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be or include a polymer film formed of any one polymer such as or including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness in a range of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. An average particle diameter (D₅₀) of the inorganic particles may be in a range of about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked together.

The thickness of the coating layer may be in a range of about 0.5 μm to about 20 μm, for example, about 1 μm to about 10 μm, or about 1 μm to about 5 μm.

FIG. 20 is a flow chart illustrating a method of preparing a positive electrode, according to examples of the disclosure. The method 2000 starts with operation 2010, which includes mixing a graphite-based material into a solution including a phosphorus extinguishing agent to obtain a mixed solution. Operation 2020 includes mixing potassium permanganate into the mixed solution to obtain a first solution. Operation 2030 includes mixing hydrogen peroxide into the first solution to obtain a second solution. Operation 2040 includes mixing an acetic acid solution with the second solution to obtain a third solution, and drying a resulting mixture. Operation 2050 includes mixing the resulting mixture with a solvent to obtain a slurry for forming a positive electrode coating layer. Operation 2060 includes coating the slurry on the positive electrode collector, and drying the slurry to form a positive electrode coating layer. Operation 2070 includes forming a positive electrode active material layer on the positive electrode coating layer. In various examples, the positive electrode coating layer includes about 1 part by weight to about 45 part by weight of the phosphorus-based extinguishing agent based on 100 parts by weight of a total of the graphite-based material and the phosphorus-based extinguishing agent.

Examples and comparative examples of the present disclosure are described below. However, the following examples are only examples of the present disclosure, and the present disclosure is not limited to the following examples.

### Preparation Example 1

After mixing phosphoric acid (H₃PO₄) and sodium nitrate (NaNO₃) to prepare a solution, graphite was added to the solution and stirred at 250 rpm for 1 hour at 25° C. Subsequently, potassium permanganate (KMnO₄) was added thereto and stirred at 250 rpm for 2 hours at 35° C. Then, hydrogen peroxide (H₂O₂) was added thereto and then, stirred at 250 rpm for 30 minutes at 98° C. The obtained mixture was added to acetic acid (CH₃COOH) and stirred at 250 rpm for 30 minutes at 40° C. and then, washed and dried. The dried resultant was added again to a phosphoric acid (H₃PO₄) solution for additional acid treatment and stirred at 250 rpm for 12 hours at 25° C. and dried to prepare an expandable graphite-based material in which phosphoric acid (H₃PO₄) as an intercalator was inserted into graphite oxide.

### Preparation Example 2

An expandable graphite-based material was obtained substantially in the same manner as in Preparation Example 1, with a difference that the additional acid treatment for the dried expandable graphite-based material was not performed.

### Preparation Example 3

An expandable graphite-based material was obtained substantially in the same manner as in Preparation Example 1, with a difference that the additional acid treatment for the dried expandable graphite-based material was performed by increasing the mixing time to 18 hours after the addition again to the phosphoric acid (H₃PO₄) solution.

### Example 1

97 wt % of the expandable graphite-based material of Preparation Example 1, in which phosphoric acid (H₃PO₄) as an intercalator was inserted into graphite oxide, and 3 wt % of a PVDF binder were mixed in an NMP solvent to prepare a slurry for forming a positive electrode coating layer. The slurry for forming a positive electrode coating layer was coated on an aluminum foil current collector and dried at 110° C. in an oven to form a positive electrode coating layer with an average thickness of 2 μm.

Subsequently, 98.15 wt % of a positive electrode active material (LiCoO₂), 0.8 wt % of carbon black, and 1.05 wt % of a PVDF binder were mixed in an NMP solvent to prepare a positive electrode slurry, and the positive electrode slurry was coated on the positive electrode coating layer and then, dried and compressed to manufacture a positive electrode. Herein, the positive electrode had a loading level of 19.28 mg/cm² and mixture density of about 4.22 g/cc.

A negative electrode slurry was prepared by mixing 97.5 wt % of graphite negative electrode active material, 1 wt % of carboxymethyl cellulose, and 1.5 wt % of styrene butadiene rubber in a water solvent. The negative electrode slurry was coated on a copper foil current collector, dried, and pressed, manufacturing a negative electrode.

The positive and negative electrodes were used with a polytetrafluoroethylene separator and an electrolyte solution prepared by dissolving 1 M LiPF₆ in a mixed solvent of ethylene carbonate and dimethyl carbonate in a volume ratio of 3:7 to manufacture a rechargeable lithium battery cell in a common method.

### Example 2

A positive electrode and a rechargeable lithium battery cell were manufactured substantially in the same manner as in Example 1, with a difference that the positive electrode coating layer was formed by using 98 wt % of the expandable graphite-based material, in which phosphoric acid (H₃PO₄) as an intercalator was inserted into graphite oxide, and 2 wt % of a PVDF binder during the manufacture of the positive electrode.

### Example 3

A positive electrode and a rechargeable lithium battery cell were manufactured substantially in the same manner as in Example 1, with a difference that the positive electrode coating layer was formed by using 99 wt % of the expandable graphite-based material, in which phosphoric acid (H₃PO₄) as an intercalator was inserted into graphite oxide, and 1 wt % of a PVDF binder during the manufacture of the positive electrode.

### Comparative Example 1

A positive electrode and a rechargeable lithium battery cell were manufactured substantially in the same manner as in Example 1, with a difference that the positive electrode coating layer was not formed during the manufacture of the positive electrode.

### Evaluation Example 1: Evaluation of Content of Each Component for Expandable Graphite-Based Material in which Phosphoric Acid is Inserted as Intercalator into Graphite Oxide

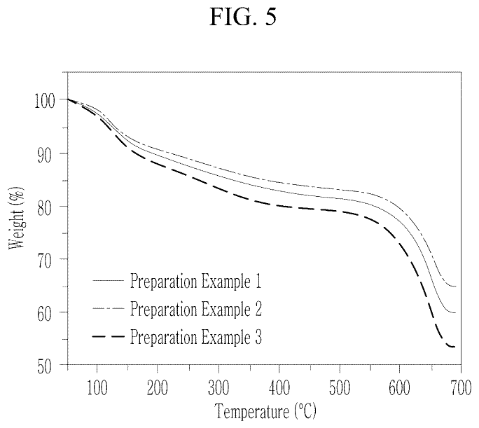

The expandable graphite-based materials of Preparation Example 1 to 3, in which phosphoric acid (H₃PO₄) as an intercalator was inserted into graphite oxide, were evaluated with respect to a content of phosphoric acid (H₃PO₄) based on 100 parts by weight of a total of graphite oxide and phosphoric acid by measuring a weight change within a range of 50° C. to 700° C. with a thermogravimetric analyzer (TGA), and the results are shown in FIG. 5, which are used to calculate the weight change of each component. Herein, because the weight change started at 550° C. where the phosphoric acid (H₃PO₄), an intercalator, started to decompose, a weight loss within the range of 550° C. to 700° C. was used to calculate a content of phosphoric acid (H₃PO₄) based on 100 parts by weight of a total of graphite oxide and phosphoric acid.

Referring to the results of FIG. 5, the content of the phosphoric acid (H₃PO₄) based on 100 parts by weight of the total of the graphite oxide and the phosphoric acid was 19 parts by weight in Preparation Example 1, 17 parts by weight in Preparation Example 2, and 23 parts by weight in Preparation Example 3. From the above results, it can be determined that a weight ratio of the phosphoric acid in the expandable graphite-based material was controlled through the additional acid treatment process of adding the expandable graphite-based material obtained by drying again to a phosphoric acid (H₃PO₄) solution, and subsequently mixing the dried expandable graphite-based material and the phosphoric acid (H₃PO₄) solution.

### Evaluation Example 2: Volume Change Evaluation

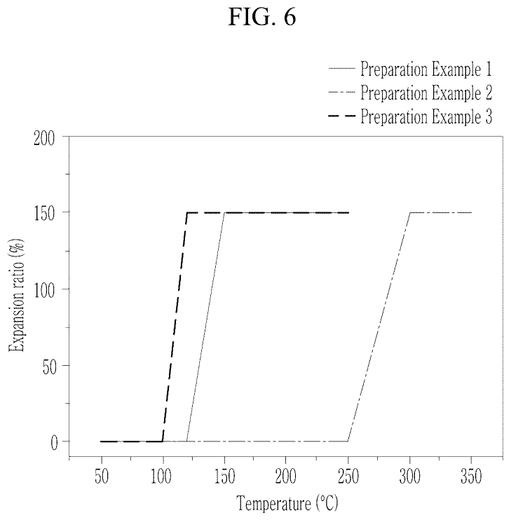

In order to evaluate a volume change of an expandable graphite-based material according to a temperature change, the expandable graphite-based materials of Preparation Examples 1 to 3, in which phosphoric acid (H₃PO₄) as an intercalator was inserted into graphite oxide, were measured with respect to a volume change within a range of 50° C. to 350° C. to evaluate an expansion rate, and the results are shown in FIG. 6.

Referring to FIG. 6, the expandable graphite-based material, in which phosphoric acid as an intercalator was inserted into graphite oxide, remained stable without a volume change within a range of greater than or equal to 50° C. to less than 100° C., but was in an expanded state at a temperature of greater than or equal to about 100° C., that is, had an increased volume.

In particular, the expandable graphite-based material of Preparation Example 1, in which phosphoric acid as an intercalator was inserted into graphite oxide, was in an expanded state at 150° C., the expandable graphite-based material of Preparation Example 2, in which phosphoric acid as an intercalator was inserted into graphite oxide, was in an expanded state at 300° C., and the expandable graphite-based material of Preparation Example 1, in which phosphoric acid as an intercalator was inserted into graphite oxide, was in an expanded state from 120° C. In the expandable graphite-based materials, in which phosphoric acid as an intercalator was inserted into graphite oxide, the graphite oxide, while changed to graphene oxide, was confirmed to expand according to the increasing temperature.

Accordingly, because the expandable graphite-based materials of Preparation Examples 1 to 3, in which phosphoric acid as an intercalator was inserted into graphite oxide, expanded in volume according to temperature changes, the expandable graphite-based materials were confirmed to be applied to a positive electrode coating layer by setting a different temperature change environment to ensure safety.

However, because the vacuum-drying in the positive or negative electrode manufacturing process is performed at about 140° C., but when an internal temperature of rechargeable batteries reaches about 200° C. or higher, because the internal battery temperature keeps being increased by an active exothermic reaction according to decomposition of components inside the rechargeable batteries, thereby deteriorating safety, the expandable graphite-based material, in which phosphoric acid as an intercalator is inserted into graphite oxide, remained stable at 140° C. or so, but a safety coating layer may effectively function at 200° C. or lower.

Accordingly, Preparation Example 1 having 19 parts by weight of the phosphoric acid (H₃PO₄) based on 100 parts by weight of the total of the graphite and the phosphoric acid exhibited an effectively secure and desired safety for the rechargeable batteries.

### Evaluation Example 3: Chemical Composition Analysis of Expandable Graphite Material

In order to determine whether phosphoric acid (H₃PO₄) was effectively present as an intercalator in the expandable graphite-based material of Preparation Example 1, the expandable graphite-based material of Preparation Example 1, in which the phosphoric acid as an intercalator was intercalated into graphite oxide, was analyzed through high-resolution X-ray photoelectron spectroscopy (XPS) to determine whether or not an element P was present in its chemical composition. Herein, the XPS analysis was performed by using K-Alpha⁺ (Thermo Fisher Scientific Co., USA), and all XPS spectra were collected with reference to a C 1s peak at 284.8 eV.

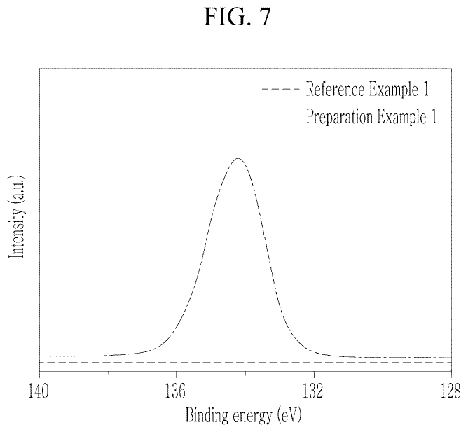

The expandable graphite-based material of Preparation Example 1, the expandable graphite-based material of Preparation Example 1, in which the phosphoric acid as an intercalator was intercalated into graphite oxide, and general graphite as Reference Example 1 were analyzed with respect to P 2p spectra, and the results are shown in FIG. 7.

Referring to FIG. 7, the general graphite of Reference Example 1 was confirmed to exhibit no P 2p spectrum, that is, no P element. On the contrary, the expandable graphite-based material of Preparation Example 1 exhibited the P 2p spectrum, that is, the presence of the P element. Whether the phosphoric acid (H₃PO₄) was present on the surface of the expandable graphite-based material or intercalated between layers was determined by additional analyses.

### Evaluation Example 4: Analysis of Lattice Structure of Expandable Graphite Material

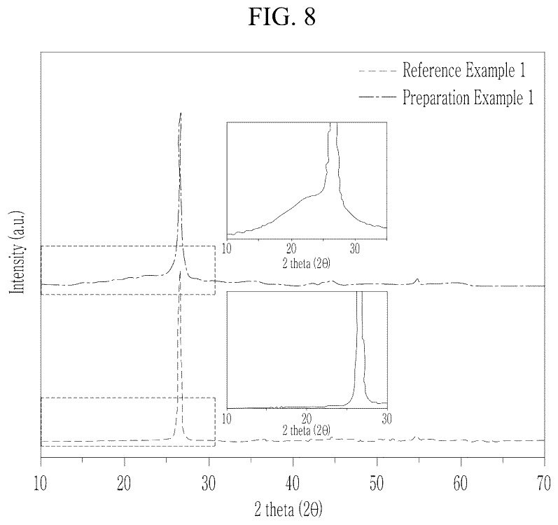

In order to analyze whether phosphoric acid (H₃PO₄) was intercalated as an intercalator between layers or present on the surface in the expandable graphite-based material of Preparation Example 1, an X-ray diffraction (XRD) analysis was performed. Through this, the general graphite of Reference Example 1 and the expandable graphite-based material of Preparation Example 1 were analyzed with respect to a lattice structure, and the results are shown in FIG. 8.

Referring to FIG. 8, the general graphite exhibited a sharp (002) peak, which corresponds to a substantially uniform interlayer distance.

On the other hand, the expandable graphite-based material of Preparation Example 1 exhibited a broad (002) peak at about 15° to 30°, which confirmed but various interlayer distances that were not uniform.

Accordingly, in the material of Preparation Example 1, in which phosphoric acid (H₃PO₄) was intercalated between layers rather than on the surface of the expandable graphite-based material, the phosphoric acid (H₃PO₄) was present as an intercalator.

### Evaluation Example 5: Conductivity Evaluation

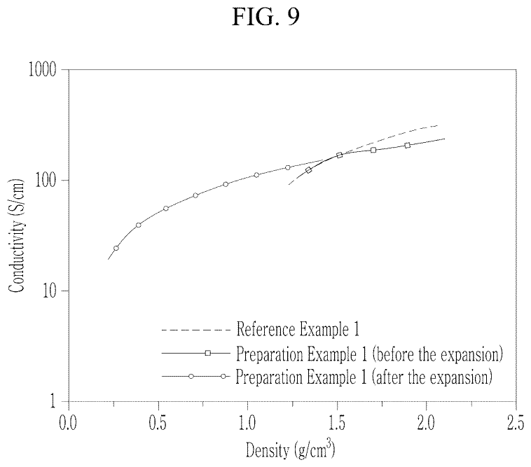

In order to evaluate changes in electronic conductivity, the expandable graphite-based material of Preparation Example 1, in which the phosphoric acid (H₃PO₄) as an intercalator was intercalated into graphite oxide, was prepared respectively before and after the expansion at greater than or equal to about 100° C. as in Evaluation Example 2 to evaluate the electronic conductivity, and the results are shown in FIG. 9.

Herein, the electronic conductivity was measured by using a powder resistance meter. The corresponding equipment measures a resistance value of powder that changes according to a pressure and a thickness, which is used to analyze the electrical conductivity. Electronic conductivity of the general graphite of Reference Example 1 and each electronic conductivity before and after the expansion according to 0.25 g/cm³ to 2.25 g/cm³ of density of the expandable graphite-based material of Preparation Example 1, in which the phosphoric acid (H₃PO₄) as an intercalator was intercalated into graphite oxide are illustrated in FIG. 9.

Referring to FIG. 9, the expandable graphite-based material of Preparation Example 1, in which the phosphoric acid (H₃PO₄) as an intercalator was intercalated into graphite oxide, exhibited equivalent electronic conductivity characteristics before the expansion to the general graphite of Reference Example 1. On the contrary, the expandable graphite-based material of Preparation Example 1, in which the phosphoric acid (H₃PO₄) as an intercalator was intercalated into graphite oxide, after the expansion, compared with the general graphite or that before the expansion, exhibited significantly low electronic conductivity characteristics.

Accordingly, the expandable graphite-based material of Preparation Example 1, in which the phosphoric acid (H₃PO₄) as an intercalator was intercalated into graphite oxide, may be used for a positive electrode coating layer, to effectively hinder or block electronic conductivity during the abnormal temperature rise to greater than or equal to about 100° C., thereby securing battery safety.

### Evaluation Example 6: SEM Evaluation

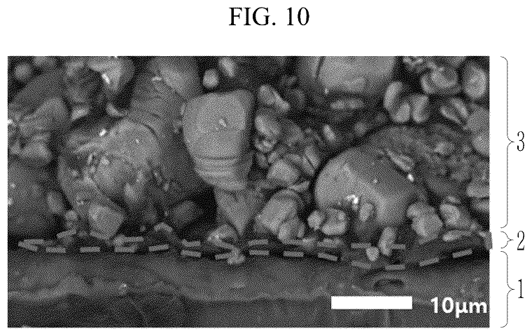

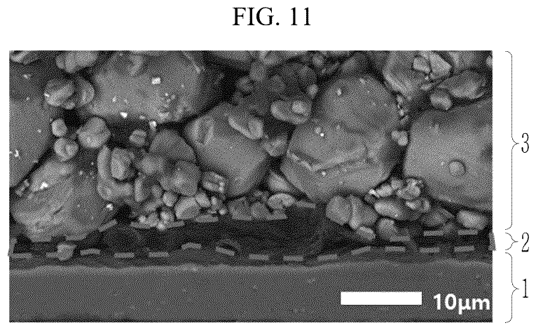

In order to observe whether a positive electrode coating layer expanded and changed in thickness at an abnormal temperature, the positive electrode specimen of Example 1 was heat-treated to 150° C. Herein, an image of a cross-section of the positive electrode specimen before the heat treatment to 150° C. was taken with scanning electron microscope (SEM) and then, shown in FIG. 10, and another image of the cross-section of the positive electrode specimen after the heat treatment at 150° C. with the scanning electron microscope (SEM) was taken and then, shown in FIG. 11.

Referring to FIGS. 10 and 11, the positive electrode current collector 1, the positive electrode coating layer 2, and the positive electrode active material layer 3 are distinctively illustrated, and a thickness of the positive electrode coating layer is indicated by a dotted line.

Referring to FIGS. 10 and 11, in order to evaluate whether or not the positive electrode coating layer 2 expanded or exhibited a thickness change, whether the thickness in the cross-section specimen of the positive electrode coating layer 2 increased or not was evaluated, wherein FIG. 10 shows that the positive electrode coating layer 2 had an average thickness of 1.7 μm, and FIG. 11 shows that the positive electrode coating layer 2 had an average thickness of 4.4 μm. Herein, the average thickness was obtained by measuring each thickness at 10 points at random equal intervals, and then calculating an average of the thicknesses.

Accordingly, after the heat treatment at 150° C., because the positive electrode coating layer 2 was confirmed to expand and have an increased thickness, which shows that in a case of abnormal temperature rise to above 150° C., a distance between expanded graphite in the expanded positive electrode coating layer 2 may be secured to actively hinder or block electrons, thereby ensuring battery safety.

### Evaluation Example 7: Resistance Evaluation

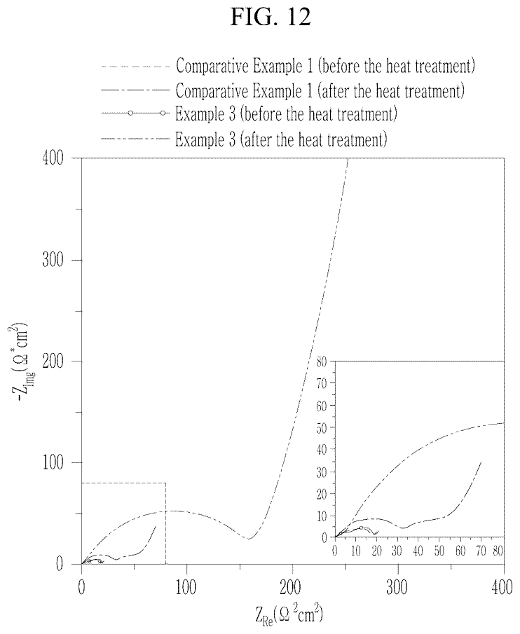

In order to evaluate a resistance change according to a temperature, the rechargeable lithium battery cells of Comparative Example 1 and Example 3 were measured with respect to resistance changes before and after the heat treatment at 150° C. for 10 minutes. Herein, the resistance was measured through electrochemical impedance spectroscopy (EIS), which was performed with an amplitude of 50 mV at a frequency of 100 kHz to 10 mHz under an air atmosphere at 25° C., and the impedance results is shown as a Nyguist plot in FIG. 12.

Referring to FIG. 12, Comparative Example 1 exhibited similar resistance results before and after the heat treatment with almost no resistance change. On the contrary, Example 3 exhibited very small resistance before the heat treatment but larger resistance after the heat treatment, thereby exhibiting a large resistance change.

### Evaluation Example 8: Short-Circuit Simulation Evaluation

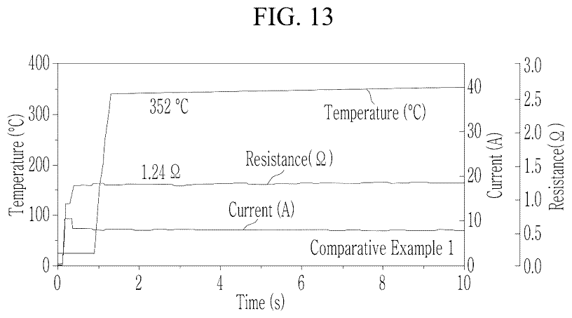

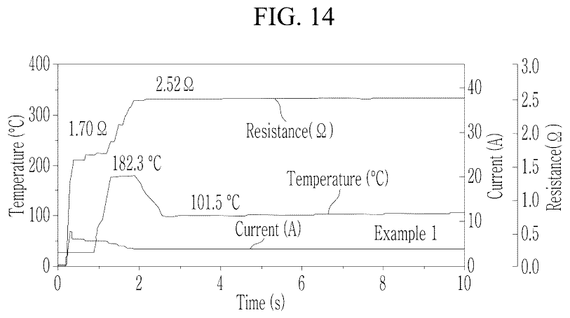

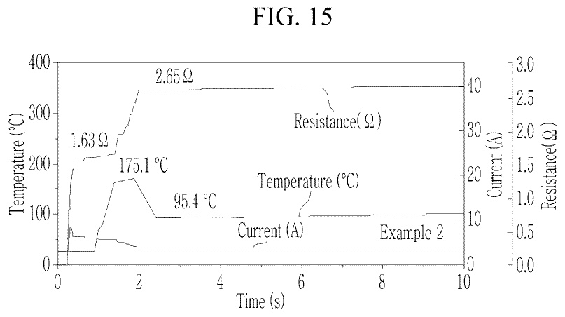

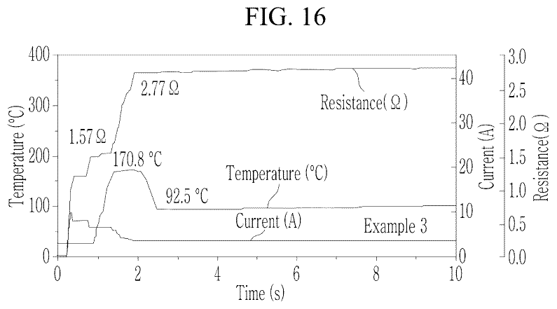

The rechargeable lithium battery cells manufactured in Comparative Example 1 and Examples 1 to 3 were subjected to a simulation evaluation, when a short-circuit occurred, and the results are shown in FIGS. 13 to 16, respectively. Herein, the short-circuit occurrence simulation evaluation was performed by using each of the positive and negative electrodes according to Comparative Example 1 and Examples 1 to 3. After sequentially stacking each manufactured negative electrode, a separator with a hole of 10 pi, and each of the positive electrode according to Comparative Example 1 and Examples 1 to 3, a stainless steel (SUS) rod was made to fit the hole size and pressed to make the positive electrode and the negative electrode contact each other in the hole. Herein, the SUS rod was pressed with a force of 5 kgf, and inside the SUS rod, a thermocouple was installed to measure a temperature change where the positive electrode and the negative electrode contacted each other. Subsequently, while a constant voltage of 10 V was applied between positive electrode and negative electrode by using a voltage supply device (power supply), a current, resistance, and a temperature were measured and analyzed.

Referring to FIG. 13, which corresponds to Comparative Example 1, when a temperature was abnormally increased for the short-circuit occurrence simulation evaluation, exhibited a temperature increase up to 352° C. but substantially no resistance change after the sharp temperature change, which confirmed that neither additional electronic conduction hindering or blocking nor extinguishing action occurred.

On the other hand, Examples 1 to 3, when a temperature was abnormally increased for the short-circuit occurrence simulation evaluation, exhibited a temperature increase to the highest temperature within the range of 170° C. to 190° C. but then, an internal battery temperature decrease down to 90° C. to 110° C.

Accordingly, the expandable graphite-based material, in which phosphoric acid as an intercalator was intercalated into graphite oxide, was confirmed to have a safety improvement effect. For example, after the sharp temperature change, the expandable graphite-based material expands and creates a distance between the substrate and the mixture, which in turn causes the temperature to decrease as illustrated by the rapid resistance increase.

### Evaluation Example 9: Evaluation of Extinguishing Characteristics after Ignition

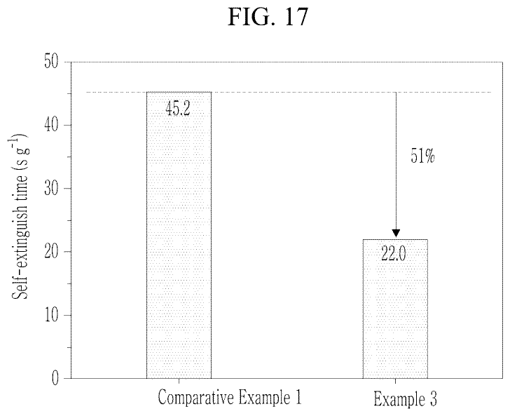

In order to analyze extinguishing characteristics of the positive electrode coating layer after ignition, after immersing the positive electrodes of Comparative Example 1 and Example 3 in an electrolyte for 24 hours so that the electrolyte was permeated inside the positive electrode, the positive electrodes were measured with respect to extinguishing time at the ignition. Herein, self-extinguishing time at the ignition was calculated as extinguishing time per weight of an electrolyte, and the results are shown in FIG. 17.

Referring to FIG. 17, Comparative Example 1 exhibited long extinguishing time after the ignition, but Example 1 exhibited a substantially short extinguishing time after the ignition. Accordingly, in Example 1, compared with Comparative Example 1, the extinguishing time was reduced by 51% or less, which confirmed that the extinguishing time was slightly reduced.

### Evaluation Example 10: Evaluation of Capacity Characteristics and Cycle-Life Characteristics

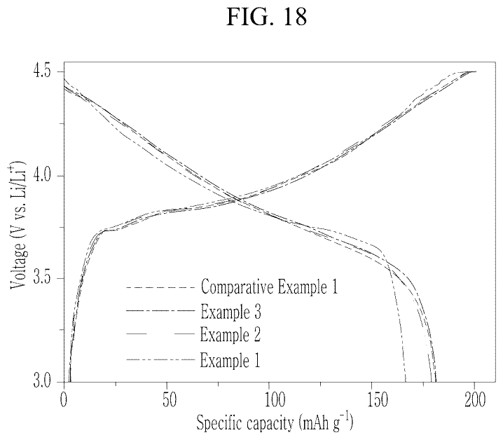

In order to evaluate capacity characteristics, initial charge/discharge was performed by charging the battery to an upper limit voltage of 4.5 V at a constant current of 0.1 C and discharging to a cut-off voltage of 3 V at 0.1 C at 25° C. (first cycle). Subsequently, a second cycle proceeded within the same voltage range under the condition of 0.2 C charge and 0.2 C discharge (second cycle). Then, a third cycle proceeded within the same voltage range under the condition of 0.5 C charge and 0.5 C discharge (third cycle). A voltage change to capacity at the initial charge and discharge was measured, and the results of the first cycle are shown in FIG. 18.

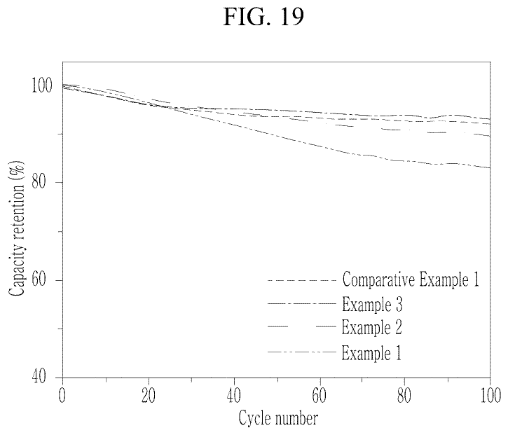

In addition, in order to evaluate cycle-life characteristics, after the above initial charge and discharge, the cells were 100 times or more repetitively charged and discharged at 1 C within a voltage range of 3 V to 4.5 V at 25° C. to measure capacity retention (%) according to the number of cycles, and the results are shown in FIG. 19.

Referring to FIGS. 18 and 19, Examples 1 to 3, compared with Comparative Example 1 in which a positive electrode coating layer was not introduced, exhibited equivalent capacity characteristics and cycle-life characteristics. In particular, Example 3, compared with Examples 1 and 2, was confirmed to exhibit desired or improved cycle-life characteristics.

Accordingly, even when a safety coating layer was introduced into a positive electrode by using the expandable graphite-based material, in which phosphoric acid (H₃PO₄) as an intercalator was introduced into graphite oxide to provide electron-hindering or electron-blocking and extinguishing functions, the safety coating layer was confirmed to effectively act as a safety functional layer at the abnormal temperature rise, or at the ignition, without significantly deteriorating capacity characteristics or cycle-life characteristics in normal times.

While this disclosure has been described in connection with what is presently considered to be practical example embodiments, it is to be understood that the disclosure is not limited to the disclosed embodiments. On the contrary, the disclosure is intended to cover various modifications and equivalent arrangements included within the spirit and scope of the appended claims.

### DESCRIPTION OF SYMBOLS

| | |
|---|---|
| 1: positive electrode current collector | 2: positive electrode coating layer |
| 3: positive electrode active material | |
| layer | |
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. A positive electrode, comprising:
a positive electrode current collector;
a positive electrode active material layer on the positive electrode current collector; and
a positive electrode coating layer between the positive electrode current collector and the positive electrode active material layer;
wherein the positive electrode coating layer includes a graphite-based material, a phosphorus-based extinguishing agent, and a binder, and
the positive electrode coating layer includes about 1 part by weight to about 45 part by weight of the phosphorus-based extinguishing agent based on 100 parts by weight of a total of the graphite-based material and the phosphorus-based extinguishing agent.

2. The positive electrode as claimed in claim 1, wherein the graphite-based material comprises at least one of a plate-shaped graphite-based material, a flake-shaped graphite-based material, and a massive graphite-based material.

3. The positive electrode as claimed in claim 1, wherein the graphite-based material comprises at least one of graphite, graphite oxide, graphene, and graphene oxide.

4. The positive electrode as claimed in claim 1, wherein the graphite-based material expands at a temperature greater than or equal to about 100° C.

5. The positive electrode as claimed in claim 1, wherein:
the graphite-based material comprises graphite oxide, and
the graphite oxide changes into graphene oxide at a temperature greater than or equal to about 100° C.

6. The positive electrode as claimed in claim 1, wherein in the positive electrode coating layer, the phosphorus-based extinguishing agent is inside the graphite-based material.

7. The positive electrode as claimed in claim 6, wherein the phosphorus-based extinguishing agent comprises at least one of phosphoric acid, a phosphate salt, phosphorous acid, a phosphite salt, metaphosphoric acid, a metaphosphate salt, pyrophosphoric acid, a pyrophosphate salt, triphosphoric acid, a triphosphate salt, tetraphosphoric acid, a tetraphosphate salt, polyphosphoric acid, and a polyphosphate salt.

8. The positive electrode as claimed in claim 1, wherein the positive electrode coating layer comprises about 55 parts by weight to about 99 parts by weight of the graphite-based material based on 100 parts by weight of a total of the graphite-based material and the phosphorus-based extinguishing agent.

9. The positive electrode as claimed in claim 1, wherein the positive electrode coating layer comprises about 50 wt % to about 99.5 wt % of the graphite-based material based on 100 wt % of the positive electrode coating layer.

10. The positive electrode as claimed in claim 1, wherein the positive electrode coating layer comprises about 0.5 wt % to about 45 wt % of the phosphorus-based extinguishing agent based on 100 wt % of the positive electrode coating layer.

11. The positive electrode as claimed in claim 1, wherein the positive electrode coating layer comprises about 0.1 wt % to about 5 wt % of the binder based on 100 wt % of the positive electrode coating layer.

12. The positive electrode as claimed in claim 1, wherein the positive electrode coating layer has an average thickness in a range of about 0.1 μm to about 20 μm.

13. The positive electrode as claimed in claim 1, wherein a thickness of the positive electrode coating layer increases at a temperature greater than or equal to about 100° C.

14. The positive electrode as claimed in claim 1, wherein the positive electrode coating layer does not include a positive electrode active material.

15. The positive electrode as claimed in claim 1, wherein the binder comprises a fluorine-based binder.

16. A method of preparing a positive electrode, the method comprising:
mixing a graphite-based material into a solution including a phosphorus extinguishing agent to obtain a mixed solution,
mixing potassium permanganate into the mixed solution to obtain a first solution,
mixing hydrogen peroxide into the first solution to obtain a second solution,
mixing an acetic acid solution with the second solution to obtain a third solution, and drying a resulting mixture,
mixing the resulting mixture with a solvent to obtain a slurry for forming a positive electrode coating layer,
coating the slurry on the positive electrode collector, and drying the slurry to form a positive electrode coating layer, and
forming a positive electrode active material layer on the positive electrode coating layer,
wherein the positive electrode coating layer includes about 1 part by weight to about 45 part by weight of the phosphorus-based extinguishing agent based on 100 parts by weight of a total of the graphite-based material and the phosphorus-based extinguishing agent.

17. A rechargeable lithium battery, comprising:
the positive electrode as claimed in claim 1;
a negative electrode; and
an electrolyte.
